(19) United States
(12) Patent Application Publication
(10) Pub. No.: US 2006/0129681 A1
(43) Pub. Date: Jun. 15, 2006

(54) Secured method to exchange data between data between browser and a web site

(75) Inventor: Francois Sendra, Paris (FR)

Correspondence Address: OSHA LIANG L.L.P., 1221 MCKINNEY STREET, SUITE 2800, HOUSTON, TX, 77010, US

(73) Assignee: AXALTO SA, Montrouge (FR)

(21) Appl. No.: 10/524,854

(22) PCT Filed: Aug. 19, 2003
(86) PCT No.: PCT/IB03/03374

§ 371 Date: Feb. 18, 2005

(30) Foreign Application Priority Data
Aug. 19, 2002 (FR) 0210463

(51) Int. Cl. G06F 15/16

(52) U.S. Cl. 709/229

(57) ABSTRACT

The invention concerns a communication between a data processing device (MOB1) and a number of resources (WEB1,WEB2) via a browser (BW1). According to the invention, the browser (BW1) comprises a number of private zones (ZP1-ZP2). Each private zone can be allocated to a respective set of resources (WEB1) and can store security information ensuring secured communication between a private zone (ZP1) and the set of resources (WEB1). In addition, the device comprises a plug-in ensuring that a set of resources (WEB1) communicates exclusively with the private zone (ZP1) allocated to it.

### TECHNICAL FIELD

The invention concerns a secured method to exchange data between two data processing devices. This invention applies especially to a data exchange between a device including preferably a smart card equipped with a browser and at least one computer resource such as a WWW (World Wide Web) site more commonly called a WEB site, or a server including services, or any other system which can exchange data with the browser.

Any type of device can be coupled with the smart card. This device can be onboard or not. Note that an onboard system is for example a mobile telephone, an electronic assistant, a portable computer, etc.

The method of the invention applies especially to communications using a symmetric type encryption algorithm.

The example which will be used to illustrate the invention will be that of a smart card coupled to an onboard system communicating with a number of WEB sites.

### STATE OF THE ART

A card generally includes a web browser, also called navigation software by those skilled in the art. This browser enables a mobile telephone to access on line services or WAP type local services.

To perform a secured data exchange between a browser stored in the smart card and a WEB site, cryptographic means are used, such as encryption or an electronic signature.

There are two types of cryptography:
traditional cryptography using symmetric keys,
public key cryptography using asymmetric keys.

Use of public key cryptography requires a large amount of memory. It is extremely difficult to implement in a smart card where the memory size is limited in terms of the number of bytes. Most browsers therefore use symmetric key cryptography. The use of symmetric key cryptography, however, also causes problems in a smart card. The browser is in fact unable to store all the keys of all the WEB sites it communicates with. Consequently, when the browser user wants to make a secured data exchange with a WEB site, the WEB site must first transmit the keys to the browser in order to use them afterwards during encryption and/or signature operations. The problem today is that the WEB sites refuse to share their keys with other WEB sites. In other words, if a WEB site “A” installs keys in a browser for later use, this WEB site “A” will not allow WEB site “B” to erase them or use them.

This situation creates a “security breach” for the secured transactions based on symmetric encryption and, consequently, a lack of trust from both WEB site users and owners/managers.

### THE INVENTION

One objective of the invention is to obtain better trust when using the smart card to make transactions.

The invention concerns a smart card comprising a browser to communicate with a WEB site including WEB pages, characterised in that the browser comprises a number of private zones (ZP1-ZP2), where each private zone can be allocated to a respective set of resources (WEB1) to store information, said device comprising a plug-in (VBA) designed to guarantee that a set of resources (WEB1) communicates exclusively with the private zone (ZP1) allocated to it.

A private zone comprises application data used to set up a secured link with a set of resources. This data may consist of symmetric encryption keys, resident pages, etc.

Note that a set of resources can include one or more WEB sites.

In the card therefore, each zone can be allocated to a particular set of WEB sites. The application data forming each private zone can therefore only be accessed by the set of WEB sites concerned, thereby preventing another set of WEB sites from using a zone which has not been allocated to it.

It will be easier to understand the invention on reading the description below, given as an example and referring to the attached drawings.

In the drawings:

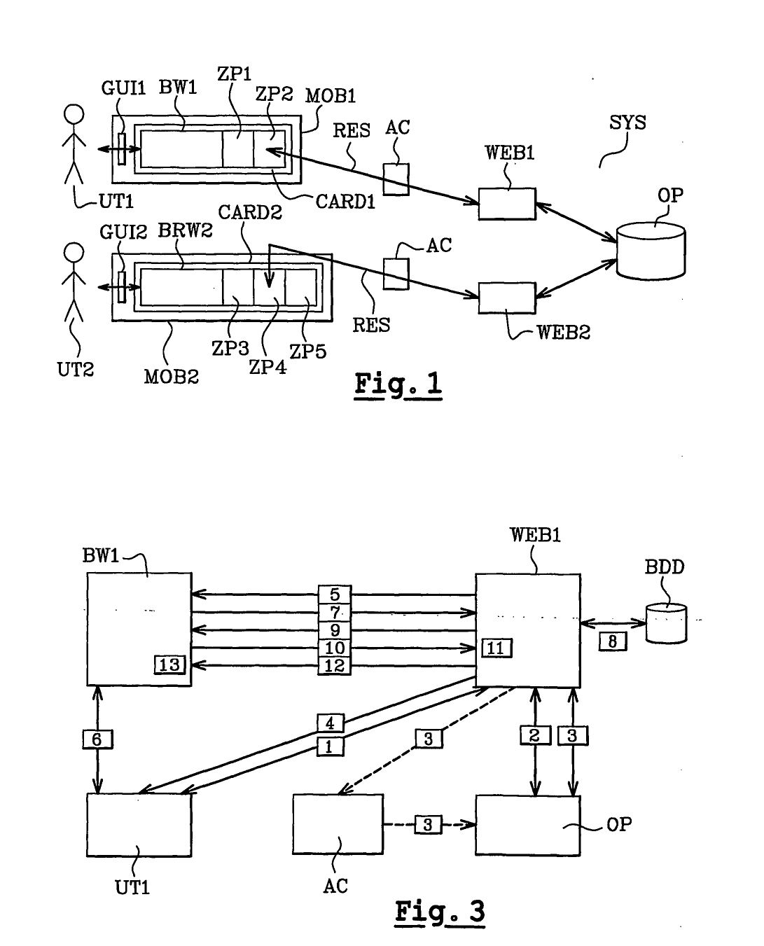

FIG. 1 is a view of a computer system on which the invention can be applied.

FIG. 2 is a view of the two major steps forming a secured transaction.

FIG. 3 is a diagrammatic view of the various steps illustrating an example of data exchange between a browser and a number of WEB sites.

FIGS. 4 to 6 are diagrammatic views of the input and output parameters of program examples implementing the invention.

### DETAILED DESCRIPTION OF AN EXAMPLE ILLUSTRATING THE INVENTION

To simplify the description, the same elements concern the same references.

FIG. 1 represents a computer system SYS. In our illustrated example, this system includes two browsers (BW1-BW2) stored in a respective smart card (CARD1-CARD2). In our example of realisation, each smart card (CARD1-CARD2) is coupled to a respective mobile telephone (MOB1-MOB2). Note that a browser can be stored either in the card or in the mobile telephone.

A browser can communicate via a network RES with a number of sites WEB1 and WEB2 managed, in our example, by a manager OP. Generally, there is an access provider AC on the network between the browser BW1-BW2 and a site WEB1-WEB2. Other components may of course be inserted, but they are not essential in the description of the invention.

In our example, each user UT1-UT2 interacts with the respective browser BW1-BW2 via a respective graphic user interface GUI1 and GUI2.

According to the invention, each browser BW1 and BW2 includes private zones ZP1-ZP2 and ZP3-ZP5, respectively. Each private zone includes application data.

For security reasons, these zones are stored in the smart card. The zones can therefore only be accessed by the user who owns the smart card.

Preferably, each zone includes:
a parameter VASid identifying the private zone in question. Preferably, this value is a default value;
a key VMK; this key VMK will be known as the master key in the remainder of the description;
possibly, a home page specific to the private zone;
possibly, a set of resident pages associated with the home page;

Preferably, the value of the key VMK is entered before using the private zone.

In our illustrated example, the method includes two main steps:
A) the authentication AUT,
B) the administration ADM.

An example illustrating the method of the invention is given below, in reference to FIGS. 2 and 3. Note that in this example, we consider that user UT1 wants to communicate with the site WEB1. In order to simply the description of the invention, the card CARD1 and the mobile telephone MOB1 have not been shown on FIG. 3; only the browser BW1 is shown.

A) Authentication

Step 1

Initially, user UT1 wants to obtain a service from the site WEB1 and communicate in complete security with this site.

In our example, the user contacts the administrator of the site WEB1 and supplies the name of the manager OP of the browser BW1; the purpose of this manager is in particular to supply certain parameters to the site WEB1 enabling it to communicate with the private zone it was allocated and not another private zone.

The user can also give the name of the access provider AC to the administrator of the site WEB1. In this case, in step 2, the site WEB1 contacts the manager OP via the access provider AC (this case is represented by the dotted lines on FIG. 3).

Step 2

In our example of realisation, a plug-in is executed when the WEB site wants to be allocated a private zone. The main purpose of this plug-in is to query the manager OP. During a second step, the site WEB1 contacts the manager OP.

This manager stores a private zone allocation table. For each zone in the browser therefore, this manager can determine whether or not it is allocated to a WEB site. Preferably, this manager OP is centralised. Several decentralised managers would also be possible. In this case, the system requires a tool to synchronise the data between the various managers, since a given zone cannot be allocated to two different WEB sites.

Step 3

During a third step, a program OPG stored in the manager OP supplies to the site WEB1 all information required to carry out secured data exchange with a particular private zone. In our example of realisation, the manager supplies to the site WEB1:
the identifier VASid identifying the allocated private zone in question.
   Advantageously, the manager also supplies
the key VMK to guarantee secured communication between an allocated zone and the site WEB1.
and possibly other information such as
   the sizes of a home page and the resident pages in the card;
   the number of resident pages;
   the browser identifier BWid.
      Step 4

In our example of realisation, the administrator of the site WEB1 sends to the user, during the fourth step, the following parameters
an identifier USERID
a password PW

Preferably, the transmission is performed by a secured means such as by post.

In our example of realisation, the site WEB1 also stores these two parameters in a memory, or a database BDD it is connected to, for future use.

Step 5

During a fifth step, in our example of realisation, the site WEB1 sends to the browser BW1 a page including fields to be completed. In our example, these fields correspond:
to the identifier USERID;
and to the password PW.

These last two parameters form an access key to the zone.

In our example, this page includes a reference which can activate a plug-in VBA installed in the card.

Step 6

During a sixth step, the browser executes the plug-in VBA. The plug-in VBA has an authentication function and its main purposes are
to prompt the user to enter his identifier USERID and his password PW
and to build a query including for example the identifier USERID and the password PW.

The various execution phases of this plug-in VBA are listed below:

Plug-in VBA:

In our example of realisation and in reference to FIG. 4, this plug-in includes input parameters PE1 and output parameters PS1.

The input parameters PE1 are:
the value of the identifier VASid of the private zone allocated to the site WEB1
and references, i.e.:
   the user identifier USERID
   the user password PW.

The output parameters PS1 are:
the value of the identifier VASid
the value of the identifier USERID
the value of the identifier of the browser BW
the encrypted value of the password PW
security data such as a random number, a signature, etc.

These output parameters are stored as a query generated during phase 5 described below.

In our example of realisation, the execution of this plug-in includes several phases:

Phase 1

During the first phase, the plug-in VBA selects the private zone corresponding to the identifier VASid.

Phase 2

During a second phase, the plug-in stores the value of the identifier USERID in the private zone.

Phase 3

During a third phase, the plug-in calculates a session key using the master key VMK known both by the browser and the site WEB1, as well as other parameters such as the identifier VASid, the random number, etc. This session key is calculated using several items of information: VMK, BWid, a random number, etc. In our example of realisation, this key plays a very temporary role. It is only used to encrypt the user password.

Phase 4

During a fourth phase, the plug-in encrypts the password using the session key.

Phase 5

During a fifth phase, the plug-in builds a query.

Step 7

A seventh step consists for the card of transmitting the query to the site WEB1.

Step 8

The site WEB1 checks the query received, in this case the identifier USERID and the password PW. In order to do this, the site WEB1 first generates the session key which must be identical to that generated by the browser during phase 3 of step 6. The site WEB1 can then decrypt the password PW using the session key VMK. To carry out this check, the site WEB1 queries the database BDD, and compares the identifier and the password received from the browser with those previously stored in the database BDD.

In our example, the site WEB1 also calculates the signature of the query received, using the session key. It then compares the result with the signature included in the message.

Step 9

If the check result is positive, the authentication is finished. The private zone and the card can communicate. In our example, if the result is positive, the site WEB1 sends to the card a page including:
a plug-in VA
a plug-in IVK
a plug-in IRP

The purpose of this page, or more precisely the associated plug-ins, is to administer the private zone allocated to the site WEB1.

B) Administration

Once authentication has been carried out, the card is administered by plug-ins which allow the browser to use the private zone allocated to a site WEB1.

Consequently, during the ninth step, administration of the private zones starts. The browser executes this page, i.e. all plug-ins VA, IVK, IRP. The various execution phases of the plug-ins VA, IVK, IRP are listed in the remainder of the description.

The plug-in VA

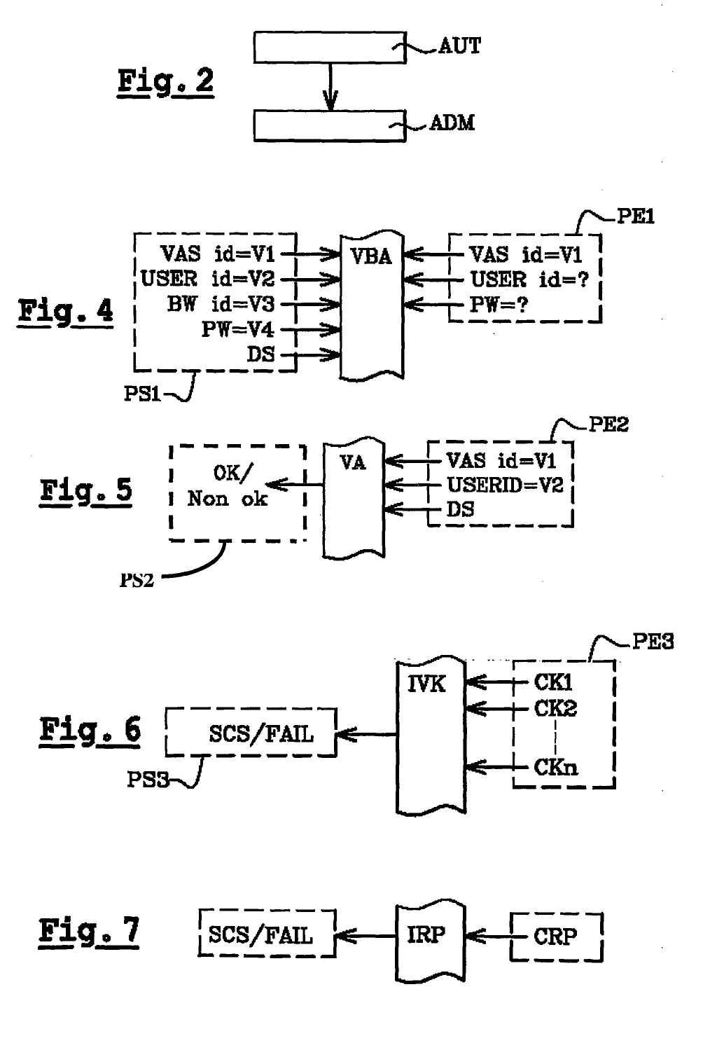

Firstly, it executes the plug-in VA. FIG. 5 illustrates a diagrammatic example of the inputs PE2 for this plug-in. The plug-in VA carries out authentication. This plug-in allows the site WEB1 to be authenticated by the browser BW1.

In our example, this plug-in VA includes input PE2 and output PS2 parameters. The output parameter is a signal indicating whether or not a transaction can be started. In our example, the input parameters PE2 are:
the value of the identifier VASid allowing the browser to select the correct private zone;
the value of the identifier USERID;
security data.
   Execution of the Plug-in VA

FIG. 5 is a conceptual view of the plug-in VA. This view illustrates the input and output parameters of this plug-in. In our illustrated example, execution of this plug-in VA includes several phases. In our example, these phases are as follows:

Phase 1

The plug-in selects the private zone corresponding to the identifier VASid.
Phase 2

The plug-in checks the value of the identifier USERID with that stored in the private zone.

Phase 3

The plug-in calculates a session key VSK using the master key VMK as well as other data, for example a random number, a signature, a synchronisation counter, etc.

Phase 4

The plug-in VA checks the security data i.e. the random number, the signature, the synchronisation counter, etc. This check guarantees that the security data associated with the private zone in question corresponds to the security data of the private zone allocated to the site WEB1.

If the check result is positive, the browser starts a secured transaction with the site WEB1 and the private zone allocated. Otherwise, no transaction is started and the browser displays for example a public home page.

Preferably, when a transaction is started, the session key is stored since it may be used throughout a session. However, in our example of realisation, when the transaction is finished or the result of the check carried out in phase 4 is negative, the session key is erased from the memory.

A secured transaction remains open throughout the execution of the current page. Preferably, this transaction is closed when the browser receives a new page. Consequently, if a WEB site wants to use a secured transaction on several pages, it will have to insert the call of the plug-in VA at the start of each page sent to the browser.

If a transaction is started, the browser can execute the other two plug-ins IVK and IRP:

The Plug-in IVK

FIG. 6 is a conceptual view of the plug-in IVK. This view illustrates the input and output parameters of this plug-in.

The purpose of this plug-in is to load encrypted keys into the private zone. In our example of realisation, this plug-in includes several input parameters PE3 and an output parameter PS3. In our example, the input parameters are encrypted keys marked CK1-CKn which can be the master key VMK or the encryption/signature keys received from the site WEB1. These encryption/signature keys are the symmetric keys mentioned in the paragraph “State of the Art”. They are part of the “application data” mentioned in the paragraph “the Invention”. They will be used later to encrypt or sign information exchanged between the browser, in particular the private zone which has been allocated, and the site WEB1.

The output parameter PS3 is a signal indicating whether or not the loading operation was successful.

When the browser executes this plug-in IVK, it checks that a transaction has been started. In this case, the plug-in selects the private zone in question. Once the selection has been carried out, the plug-in decrypts the symmetric keys CK1-CKn received from the site WEB1 using the session key VSK and stores them in the private zone. The number of keys “n” is unimportant.

The Plug-in IRP

FIG. 7 is a conceptual view of the plug-in IRP. This view illustrates the input and output parameters of this plug-in.

In our example of realisation, the purpose of this plug-in IRP is to load either a home page encrypted in the private zone in question, or one or more encrypted resident pages. These pages are part of the “application data” mentioned in the paragraph “the Invention”.

In our example of realisation, this plug-in IRP includes an input parameter CRP which is an encrypted resident page obtained from the site WEB1. This page can either be a home page or a resident page. The output parameter SCS/FAIL is a message indicating whether or not the pages were installed successfully.

When the browser executes the plug-in IPR, it checks that a secured transaction has been started. In this case, the plug-in selects the private zone in question. The plug-in then decrypts the page received using the session key VSK and stores the page in the private zone in question.

Step 10

During the tenth step, the results obtained by the various plug-ins started during step 8 are sent to the site WEB1.

Step 11

During an eleventh step, the site WEB1 checks the results obtained by the various above-mentioned plug-ins. If the results obtained are satisfactory, the site WEB1 can use its private zone. In our example of realisation, the site WEB1 can carry out transactions by using the symmetric keys.

Step 12

During a twelfth step, the site WEB1 then sends to the browser a page which includes the plug-in VA, signature or encryption operations, a link to a resident page, etc.

Step 13

In our example, when the browser has received this page, the transaction is closed. The browser then executes the plug-in VA. If the check result is positive, the browser starts a new secured transaction with the site WEB1 and the allocated private zone. This is the utilisation phase of the private zone. The site WEB1 can thus carry out encryption and signature operations, using the symmetric keys associated with the private zone in question. The browser can also access the private resident pages previously loaded by the plug-in IRP.

This example of realisation clearly shows that a resource can be a WEB site or any other device able to communicate with a smart card. Note that the verb “communicate” includes data exchange. We have seen in particular that the authorisation to use a private zone is carried out by a plug-in including at least one input parameter corresponding to a zone access key. In our example, this access key consists of the USERID and the password PW. We have also seen that the value of this key is supplied by all resources concerned, i.e. all WEB sites in our example. This key VMK can encrypt information transiting between said zone and the set of resources. After execution and depending on this key, this plug-in can authorise access to a private zone and deny access to the other private zones.

In our example, we have seen how authentication between a private zone and a set of corresponding resources is carried out. The set of resources transmits a request to the browser prompting the user to enter the access key received. Then, if the access key is correct, the device includes code instructions which can manage the authentication between a set of WEB sites and the corresponding allocated private zone.

We have also seen that the device interprets code instructions which, after the authentication step and using security information, can manage the administration of the private zones as well as the use of application data in these private zones during a communication between the browser and the WEB site.

In our example of realisation, we have seen that the security data includes at least one master key (VMK).

The invention also concerns the computer resource. The computer resource, especially the WEB site, includes means to communicate exclusively with a private zone ZP1 of a browser BW1. We have seen that the private zones are managed by a manager OP, preferably centralised. In the remainder of the document, this centralised manager will be more generally called centralised entity. This entity OP allocates a private zone to a resource WEB1 by transmitting to the resource security parameters, in particular parameters which can identify the allocated private zone VASid, at least one master key VMK stored in the allocated private zone. This key VMK can encrypt information transiting between said zone and the set of resources. We have seen that this information may consist of session keys CK1-CKn.

The resource according to the invention comprises secured means to transmit to said device
a key PW-USERID to access a private zone;
a password PW and/or a user identifier USERID,

The device uses the above parameter(s) to authenticate, during a communication between said resource and said device, the private zone with the computer resource WEB1.

The invention also concerns a smart card storing this type of browser.

The invention also concerns the communication method. The method includes the following steps:
a step to create a number of private zones, where each private zone can be allocated to a respective set of resources and can store security information ensuring secured communication between a private zone and a set of resources;
a step to allocate a private zone to a set of resources,
a step to communicate between said allocated private zone and the set of resources concerned, a plug-in denying access to another private zone during this communication.

Advantageously, we have seen that the allocation of a private zone is managed by an entity OP. This entity allocates a private zone of the card to the set of WEB resources by supplying information, including at least:
the reference VASId of the private zone,
and the value of a master key VMK stored previously in the corresponding private zone, this key being able to encrypt information transiting between the private zone and the set of resources. We then see that, using this key (VMK), the link between the zone and the WEB site can be secured.

In our example, we have seen that the set of WEB resources transmits by a secured transmission means at least one access key (USERID,PW) associated with a private zone, said key being used to execute a plug-in able, after execution, to authorise access to a private zone and deny access to the other private zones.

In our example, we have also seen that, in order to open a secured transaction, the set of resources WEB1 transmits a plug-in which can check whether the security information written in the private zone ZP1 corresponds to the security information stored in a memory attached to the set of resources WEB1.

We have seen, in our example of realisation, that in order to implement this method, plug-ins must be installed both in the device and in the set of resources. These plug-ins include in particular the authentication plug-in VBA and a plug-in stored on an entity which can manage the allocation of private zones.

The authentication plug-in includes at least one input parameter PE1 corresponding to a zone access key (USERID,PW), the value of this key being supplied by the set of resources to said device. After execution and depending on this key, this plug-in VBA can authorise or deny access to a private zone and deny access to the other private zones if the access is authorised.

The purpose of the allocation plug-in, when it is executed on said entity, is to allocate a private zone ZP1 of said browser BW1 to a set of resources WEB1 by supplying information including at least the reference (VASId) of the private zone ZP1.

We see that this invention offers numerous advantages. Through this mechanism which “partitions” the information accessible by a browser, the encryption keys and the local pages associated with a private zone can only be accessed by the WEB site concerned and not by other WEB sites. Consequently, this partitioning mechanism provides access only to the WEB sites which installed them.

This solution also meets a second market requirements concerning the installation of local (or “resident”) pages accessible by the browser. The WEB sites can install local pages through a secured transmission and only allow access to the user after authentication. Since these local pages are “the property” of a particular WEB site, they can no longer be erased by installation of pages from another WEB site.

1. Data processing device (MOB1) which can communicate with a number of sets of resources (WEB1,WEB2) via a browser (BW1), characterised in that the browser (BW1) comprises a number of private zones (ZP1-ZP2), where each private zone can be allocated to a respective set of resources (WEB1) to store information, said device comprising a plug-in (VBA) ensuring that a set of resources (WEB1) communicates exclusively with the private zone (ZP1) allocated to it.

2. Device according to claim 1, characterised in that said plug-in (VBA) comprises at least one input parameter (USERID,PW) corresponding to a zone access key, the value of this access key being supplied through a secured transmission by the set of resources concerned (WEB1) to said device, said plug-in, after execution and depending on the key, being able to authorise access to a private zone (ZP1), and deny access to the other private zones (ZP2) of said browser (BW1).

3. Device according to claim 1 or 2, characterised in that, for the authentication step, the set of resources (WEB1) transmits a request to the browser prompting the user to enter an access key (USERID, PW) received, and in that if the access key is correct, the plug-in (VBA) comprises code instructions which can manage the authentication between a set of resources (WEB1) and the corresponding allocated private zone (ZP1).

4. Device according to claim 1, characterised in that each zone (ZP1-ZP2) can store information, in particular security information ensuring secured communication between a private zone (ZP1) and a set of resources (WEB1).

5. Device according to claim 1 or 4, characterised in that it interprets code instructions which, after the authentication step and using security information stored in the private zone concerned, can manage the administration of the private zones as well as the use of application data in these private zones during a communication between the browser and the set of resources (WEB1).

6. Computer resource (WEB1), in particular a WEB site, communicating with a data processing device (MOB1) via a network, characterised in that said device includes a browser (BW1) as defined in claim 1, and in that said computer comprises a plug-in which, when executed, can obtain the allocation of a private zone (ZP1), said allocation ensuring that the communication between said private zone (ZP1) and said resource (WEB1) is exclusive.

7. Resource according to claim 6, characterised in that the private zones are managed by an entity (OP), and in that this entity (OP) allocates a private zone (ZP1) to a resource (WEB1), said entity transmitting to said resource security parameters, in particular parameters which can identify the allocated private zone (VAS id).

8. Resource according to claim 7, characterised in that said entity transmits to said resource at least one master key (VMK) previously stored in the allocated private zone, said key being able to encrypt information transiting between said zone and the set of resources.

9. Resource according to claim 6, characterised in that it comprises secured means to transmit to said device a key (PW,USERID) to access a private zone, said device using this key, during communication between said resource and said device, to authenticate the private zone with the computer resource (WEB1).

10. Manager (OP), in particular an operator, which can manage the use of said device as defined in claim 1, characterised in that it comprises a plug-in which can manage, upon request, the allocation of a private zone (ZP1) to a set of resources by supplying to said set of resources information comprising at least the reference (VASId) of a private zone (ZP1).

11. Smart card (CARD1) which can communicate with a number of sites (WEB1) via a browser (BW1), characterised in that:
the browser comprises a number of private zones (ZP1-ZP2), where each private zone can be allocated to a respective set of sites and can store security information ensuring secured communication with a set of sites;
and in that the browser (BW1) interprets code instructions ensuring that a set of sites (WEB1) communicates exclusively with the private zone (ZP1) allocated to it.

12. Communication method between a data processing device (MOB1) comprising a browser (BW1) and a set of resources (WEB1), characterised in that it comprises the following steps:
a step to create, in said browser, a number of private zones (ZP1-ZP2), where each private zone can be allocated to a respective set of resources and can store security information ensuring secured communication between said private zone and a set of resources;
a step to allocate a private zone (ZP1) to a set of resources (WEB1),
a step to communicate between said allocated private zone (ZP1) and the set of resources concerned (WEB1), a plug-in denying access during this communication to any private zone other than the allocated zone (ZP1).

13. Method according to claim 12, characterised in that the allocation of a private zone (ZP1) is managed by an entity (OP), and in that this entity allocates a private zone (ZP1) of the card (CARD1) to the set of resources (WEB1) by supplying information comprising in particular the reference (VASId) of the allocated private zone (ZP1).

14. Method according to claim 13, characterised in that the information comprises the value of a master key (VMK) previously stored in the corresponding private zone (ZP1), this key being able to encrypt information transiting between said zone and the set of resources during a communication.

15. Method according to claim 12, characterised in that the set of resources (WEB1) transmits by a secured transmission means at least one access key (USERID,PW) associated with a private zone (ZP1), said key being used to execute a plug-in able, after execution, to authorise access to a private zone (ZP1) and deny access to the other private zones (ZP2).

16. Method according to claim 12, characterised in that, in order to open a secured transaction, the set of resources (WEB1) transmits a plug-in which can check whether the security information written in the private zone (ZP1) corresponds to the security information stored in a memory attached to the set of resources (WEB1).

17. Computer plug-in (VBA) for a data processing device (MOB1) which can communicate with a number of resources (WEB1,WEB2) via a browser (BW1), characterised in that the browser comprises a number of private zones (ZP1-ZP2), where each private zone (ZP1) can be allocated to a respective set of resources (WEB1) and can store information specific to this set of resources (WEB1), and in that the plug-in comprises at least one input parameter corresponding to a key (USERID,PW) to access a zone, the value of this key being supplied to said device by the set of resources concerned, said plug-in, after execution and depending on this key, being able to authorise or deny access to a private zone and deny access to the other private zones if the access is authorised.

18. Computer program (OPG) stored in a manager entity (OP) which can manage private zones as defined in claim 1, the purpose of said program being, when it is executed on said entity, to allocate a private zone (ZP1) of said browser (BW1) to a set of resources (WEB1) by supplying information including at least the reference (VASId) of the private zone (ZP1).
